(19) United States
(12) Patent Application Publication
(10) Pub. No.: US 2026/0065153 A1
(43) Pub. Date: Mar. 5, 2026

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventors: Gen LI, Kawasaki Kanagawa (JP); Masaaki TAKADA, Kashiwa Chiba (JP)

(73) Assignee: KABUSHIKI KAISHA TOSHIBA, Tokyo (JP)

(21) Appl. No.: 19/258,971

(22) Filed: Jul. 3, 2025

(30) Foreign Application Priority Data
Sep. 2, 2024 (JP) 2024-150881

(51) Int. Cl. G06N 20/00

(52) U.S. Cl. CPC G06N 20/00

(57) ABSTRACT

An information processing device includes a processing unit. The processing unit calculates the number of pieces of data, which is the number of pieces of input data for each of a plurality of categories, by using n pieces of input data (n is an integer of 2 or more) each including a plurality of explanatory variables including a category variable representing any one of the plurality of categories. The processing unit calculates, for a plurality of combinations each including two of the categories included in the plurality of categories, a weight based on the number of pieces of data between two of the categories included in a combination. The processing unit learns a first regression model that estimates an objective variable from the plurality of explanatory variables by using a loss function including a regularization term in which a strength of regularization changes according to the weight.

### CROSS-REFERENCE TO RELATED APPLICATIONS

This application is based upon and claims the benefit of priority from Japanese Patent Application No. 2024-150881, filed on Sep. 2, 2024; the entire contents of which are incorporated herein by reference.

### FIELD

Embodiments described herein relate generally to an information processing device, an information processing method, and a computer program product.

### BACKGROUND

In production systems such as factories (semiconductor factories and the like) and plants (chemical plants and the like), various types of products are mass-produced. In recent years, a large amount of process data can be acquired from sensors installed in each manufacturing process in a short period (for example, every day). In addition, by analyzing the accumulated data, it is possible to take measures to suppress variations in qualities. By such measures, productivity and yield are improved.

As one of such measures, regression analysis using a model (regression model) constructed by machine learning or the like is used. The regression model is, for example, a model for which process data such as a sensor value, a setting value, and a control value is used as an explanatory variable, and quality characteristics are used as an objective variable. By using the regression model, it is possible to analyze a factor (cause) of a variation in quality characteristics, estimate future quality characteristics, and the like.

### BRIEF DESCRIPTION OF THE DRAWINGS

FIG. 1 is a block diagram of an information processing system including an information processing device according to an embodiment;

FIG. 2 is a flowchart of model construction processing according to a first embodiment;

FIG. 3 is a block diagram illustrating an information processing device according to a second embodiment;

FIG. 4 is a flowchart of a model construction process according to the second embodiment;

FIG. 5 is a diagram illustrating an outline of a determination procedure of Cₘᵢₙ and Cₘₐₓ;

FIG. 6 is a block diagram of an information processing device according to a third embodiment;

FIG. 7 is a flowchart of a model construction process according to the third embodiment;

FIG. 8 is a diagram illustrating an output example of a regression coefficient estimation result; and

FIG. 9 is a hardware configuration diagram of the information processing device according to the first to third embodiments.

### DETAILED DESCRIPTION

According to an embodiment, an information processing device includes one or more hardware processors configured to calculate a number of pieces of data that is a number of pieces of input data for each of a plurality of categories, by using n pieces of input data each including a plurality of explanatory variables including a category variable representing any of the plurality of categories, where n is an integer of 2 or more. The hardware processors are configured to calculate, for a plurality of combinations each including two of the categories included in the plurality of categories, a weight based on the number of pieces of data between two of the categories included in a combination. The hardware processors are configured to learn a first regression model that estimates an objective variable from the plurality of explanatory variables by using a loss function including a regularization term in which a strength of regularization changes according to the weight.

Hereinafter, a preferred embodiment of an information processing device according to the present disclosure is specifically described with reference to the accompanying drawings. The present disclosure is not limited to the following embodiments.

In the factor analysis using the regression model, a model with high interpretability such as a linear model, a decision tree, and an additive model is often used. For each explanatory variable, an amount representing the degree of influence of the parameter of the model on the output of the model is calculated, and, by using the calculated amount, a factor that can explain the variation in the quality characteristics can be specified.

The parameters of the model are, for example, a regression coefficient of the regression model, and an importance level. Hereinafter, an example in which a regression model is used as a model, and a coefficient (regression coefficient) is used as a parameter of the model is mainly described. The applicable model and the parameter of the model are not limited thereto.

Data in a production system or the like may change in tendency from moment to moment. In order to always grasp the latest trend, periodic model update using the latest data is required. Meanwhile, when only the latest data is used, the number of pieces of data is reduced, and thus the influence of noise more strongly appears.

In particular, products belonging to a new category (such as a new product type) derived from an existing category (such as a product type) may be produced only in a small amount, and there is a high possibility that estimation of a regression coefficient for the new category becomes unstable. In such a case, it is conceivable to collect data of all categories, convert a category variable representing a category into a dummy variable and perform estimation by modeling as in the following Formula (1).

$$Y = {1}_{Category} ( A ) \times {β}_{A} + {1}_{Category} ( B ) \times {β}_{B} + Temperature \times {β}_{Temperature} + … , \qquad ( 1 )$$

$${1}_{Category} ( a ) = \{ \begin{matrix}1 & if Catogory = a \\ 0 & if Catogory \neq a\end{matrix}$$

Note that the category variable is, for example, a variable that can take a value indicating each of a plurality of categories. Such a category variable can be converted into dummy variables corresponding to the number of categories. Each dummy variable is, for example, a variable indicating whether the product belongs to the corresponding category. In Formula (1), l_{category} (a) in the second row corresponds to a dummy variable corresponding to the category “a”. A, B, and the like are examples of category values. In addition, “Temperature” in Formula (1) means an explanatory variable representing temperature.

In the method using Formula (1), estimation accuracy of a regression coefficient of a variable (explanatory variable representing temperature) common among the plurality of categories such as the βₜₑₘₚₑᵣₐₜᵤᵣₑ is improved, but the estimation accuracy of a regression coefficient (intercept for each category) for a variable (dummy variable) representing the characteristic for each category such as β_{A} or β_{B} is often not improved.

As such, as a method of improving the estimation accuracy, a method of performing estimation while integrating regression coefficients for each category (hereinafter, Method EMA) is suggested (For example, By Ryan J. Tibshirani and Jonathan Taylor, “THE SOLUTION PATH OF THE GENERALIZED LASSO.” The Annals of Statistics. 2011, Vol. 39, No. 3, 1335-1371). In Method EMA, a loss function including a regularization term is minimized. When the three categories of {A, B, C} are included, regression coefficients β_{A}, β_{B}, and β_{C} for each category can be integrated by setting a design matrix D that satisfies the following Formula (2). Formula (3) is an example of a formula representing the minimization of the loss function.

$$‖ D β ‖ = \vert {β}_{A} - {β}_{B} \vert + \vert {β}_{A} - {β}_{C} \vert + \vert {β}_{B} - {β}_{C} \vert \qquad ( 2 )$$

$${minimize}_{β} \frac{1}{2} {‖ y - X β ‖}_{2}^{2} + λ ‖ D β ‖ \qquad ( 3 )$$

Furthermore, a method using a weighted regularization term (hereinafter, Method EMB) is been suggested (for example, Mineaki Ohishi, et al., “Optimizations for Categorizations of Explanatory Variables in Linear Regression via Generalized Fused Lasso.”, 2021; and Shota Katayama, “Support recovery of adaptive generalized lasso under high-dimensionality.”, 2017 Science and Research Grant Symposium “Theory, Methodology, and Application to Related Fields for Large Complex Data”, 2017). When three categories of {A, B, C} are included, a design matrix WD can be set so as to satisfy the following Formula (4). Formula (5) is an example of a formula representing the minimization of the loss function in the method EMB.

$$‖ WDβ ‖ = {W}_{A B} \vert {β}_{A} - {β}_{B} \vert + {W}_{A C} \vert {β}_{A} - {β}_{C} \vert + {W}_{B C} \vert {β}_{B} - {β}_{C} \vert \qquad ( 4 )$$

$${minimize}_{β} \frac{1}{2} {‖ y - X β ‖}_{2}^{2} + λ ‖ WD β ‖ β \qquad ( 5 )$$

In the method EMB, a value of a weight w is set as in the following Formula (6) using an initial estimation amount β˜ obtained by normal linear regression. Formula (6) represents a setting example of w_{AB}.

$${w}_{A B} = \frac{1}{\vert {\tilde{β}}_{A} - {\tilde{β}}_{B} \vert} \qquad ( 6 )$$

When the estimation is performed using the weighted regularization term like the method EMB, the regression coefficients for each category are integrated. At that time, by referring to a result of normal linear regression, regression coefficients of two categories having close values are more easily integrated.

In manufacturing in a production system, products in new categories appear one after another due to advancement of manufacturing technology and segmentation of product specifications. In an initial stage of mass production, only a small amount of products is produced, and data for model construction cannot be sufficiently secured in some cases. When the number of pieces of data is small, even if the method EMB or the like is used, the estimation of the initial estimation amount β˜ for the small production category becomes unstable, and the calculated weight w also becomes an unstable value. Then, even if the regression coefficients of the categories are integrated based on the unstable weight w, it is highly likely that a wrong estimation result is obtained.

Meanwhile, a product in a new category is a derivative product improved based on a product in an existing category (parent product) and often has characteristics similar to those of a product in an existing category that is mass-produced. Therefore, in the following embodiment, using such a relationship, the value of the weight w is set such that the regression coefficient of the small production category is easily integrated by the regression coefficient of the mass production category.

As a result, two categories both capable of acquiring sufficient data or two categories both having small data are passively integrated, and two categories: one having large data and the other having small data are actively integrated. That is, a regression coefficient of an unstable derivative product (product of the new category) can be easily integrated into a regression coefficient of a more stable parent product.

### First Embodiment

Hereinafter, an embodiment of constructing a model that can be used for quality control in a production system is described. As described above, in the production system, variations and fluctuation in quality characteristics are suppressed, and defects are reduced, thereby taking measures to improve the yield. To clarify a variation factor of the quality characteristic and estimate a future quality characteristic, for example, a regression model is used.

The product undergoes a number of manufacturing steps to become a finished product. In the case of an application for analyzing a factor of variation in quality characteristics of a finished product, a model is constructed using information such as a type of a manufacturing device in each manufacturing process and a sensor value detected by a sensor installed in the manufacturing device as an explanatory variable of the model. Note that the information such as the type of the manufacturing device and the sensor value can be interpreted as a feature amount representing a feature of an analysis target such as a production system.

Since the manufacturing apparatus deteriorates over time, the tendency of the acquired process data also changes. In addition, operations that affect the tendency of the process data such as periodic maintenance and part replacement may be performed. Therefore, for example, the model is updated in accordance with a change in tendency of the process data.

In the model of the present embodiment, for example, the objective variable is quality characteristics, a defect rate, a variable indicating whether the product is a non-defective product or a defective product, or the like. The objective variable may be a sensor value detected by the sensor. The explanatory variables are other sensor values, setting values, control values, product type information (category information), and the like. The explanatory variable may be preprocessed in advance. Preprocessing is, for example, standardization, normalization, conversion by a specific function, addition of an interaction term, time lag, time lead, dummy variabilization, encoding, outlier processing, missing value processing, and the like.

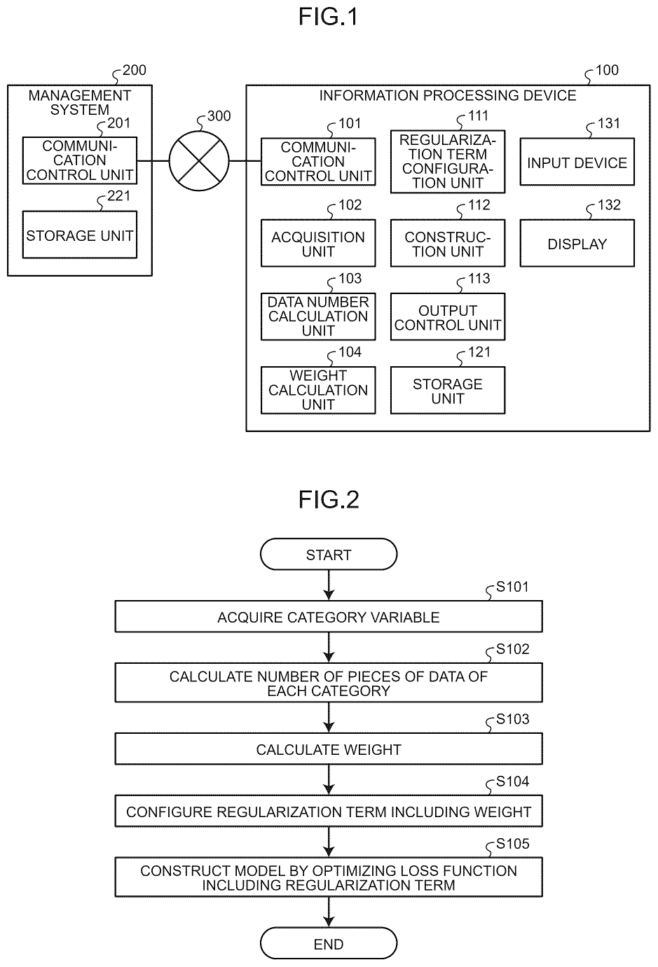

FIG. 1 is a block diagram illustrating an example of a configuration of an information processing system including an information processing device according to the present embodiment. As illustrated in FIG. 1, the information processing system has a configuration in which an information processing device 100 and a management system 200 are connected via a network 300.

Each of the information processing device 100 and the management system 200 can be configured, for example, as a server device. The information processing device 100 and the management system 200 may be realized as a plurality of physically independent devices (systems), or each function may be configured in one device physically. In the latter case, the network 300 may not be included. At least one of the information processing device 100 and the management system 200 may be constructed on a cloud environment.

The network 300 is, for example, a network such as a local area network (LAN) and the Internet. The network 300 may be either a wired network or a wireless network. The information processing device 100 and the management system 200 may transmit and receive data using direct wired connection or wireless connection between components without using the network 300.

The management system 200 is a system that manages data used for model learning (construction and update), analysis, and the like. The management system 200 includes a storage unit 221 and a communication control unit 201.

The storage unit 221 stores various types of information used in various processes performed by the management system 200. For example, the storage unit 221 stores data (process data or the like) including the objective variable and the explanatory variable. The storage unit 221 can be configured by any generally used storage medium such as a flash memory, a memory card, a random access memory (RAM), a hard disk drive (HDD), and an optical disc.

The communication control unit 201 controls communication with an external device such as the information processing device 100. For example, the communication control unit 201 transmits the process data to the information processing device 100.

Each of the above units (communication control unit 201) is implemented by, for example, one or a plurality of processors. For example, each of the above units may be implemented by causing a processor such as a central processing unit (CPU) and a graphics processing unit (GPU) to execute a program, that is, by software. Each of the above units may be implemented by a processor such as a dedicated integrated circuit (IC), that is, hardware. Each of the above units may be implemented by using software and hardware in combination.

The information processing device 100 includes a storage unit 121, an input device 131, a display 132, a communication control unit 101, an acquisition unit 102, a data number calculation unit 103, a weight calculation unit 104, a regularization term configuration unit 111, a construction unit 112, and an output control unit 113.

The storage unit 121 stores various types of information used in various processes performed by the information processing device 100. For example, the storage unit 121 stores information (process data and the like) acquired from the management system 200 via the communication control unit 101 and the acquisition unit 102, parameters (coefficients) of the model constructed by the construction unit 112, and the like. The storage unit 121 can be configured with any commonly used storage medium such as a flash memory, a memory card, a RAM, an HDD, and an optical disk.

The input device 131 is a device for inputting information by a user or the like. The input device 131 is, for example, a keyboard and a mouse. The display 132 is an example of an output device that outputs information and is, for example, a liquid crystal display. The input device 131 and the display 132 may be integrated, for example, like a touch panel.

The communication control unit 101 controls communication with an external device such as the management system 200. For example, the communication control unit 101 receives process data and the like from the management system 200. In addition, the communication control unit 101 transmits a transmission request or the like of process data in a designated period to the management system 200.

The acquisition unit 102 acquires various types of information. For example, the acquisition unit 102 acquires process data received from the management system 200 via the communication control unit 201 and the communication control unit 101.

For example, the acquisition unit 102 acquires, as data (input data) to be analyzed, process data of a designated period or process data of a designated number of pieces of data from the management system 200 via the communication control unit 101. In the present embodiment, the input data is n (n is an integer of 2 or more) pieces of data each including a plurality of explanatory variables including a category variable.

The acquisition unit 102 may acquire information indicating a category designated as a category for which a weight is set among a plurality of categories. The category designation method may be any method, and for example, a method by which the output control unit 113 outputs names of a plurality of categories and designates (selects) a category from the output names can be applied. For example, the acquisition unit 102 acquires information indicating a category corresponding to the name designated from the output name.

The data number calculation unit 103 calculates the number of pieces of data, which is the number of pieces of input data for each of the plurality of categories, using the n pieces of input data. When the information indicating the category designated as the category for which the weight is set is acquired by the acquisition unit 102, the data number calculation unit 103 may calculate the number of pieces of data for the designated category.

The weight calculation unit 104 calculates the weight of the regularization term. The weight corresponds to a weight added to the weighted regularization term as in the method EMB described above. For example, for a plurality of combinations each including two categories included in a plurality of categories, the weight calculation unit 104 calculates a weight based on the number of pieces of data between the two categories included in the combination. The weight based on the number of pieces of data between the two categories is, for example, a difference between the numbers of pieces of data of the two categories or a ratio (proportion) between the numbers of pieces of data of the two categories.

The weight calculation unit 104 may perform scaling on the weight. The scaling is, for example, the following process.
The weight is calculated so as to be a value of 0 or more and 1 or less.
A weight that is a value so that the sum of weights for a plurality of combinations is 1 is calculated.

When the information indicating the category designated as the category for which the weight is set is acquired by the acquisition unit 102, the weight calculation unit 104 may calculate the weight for a plurality of combinations each including any two categories of the designated categories.

The regularization term configuration unit 111 configures a regularization term to which the weight calculated by the weight calculation unit 104 is added. The regularization term to which the weight is added can be interpreted as a regularization term in which the strength of regularization changes according to the weight.

The construction unit 112 learns (constructs) a regression model MA (first regression model) for estimating the objective variable from the plurality of explanatory variables using the loss function including the regularization term configured with the regularization term configuration unit 111. The regression coefficient of the regression model MA is obtained by learning.

The output control unit 113 controls output of various types of information used in the information processing device 100. For example, the output control unit 113 displays information (accuracy, coefficients or the like) of the regression model MA constructed by the construction unit 112 on the display 132. As a result, for example, the expert can determine whether the estimated coefficient is within the assumed range.

At least a part of each unit (the communication control unit 101, the acquisition unit 102, the data number calculation unit 103, the weight calculation unit 104, the regularization term configuration unit 111, the construction unit 112, and the output control unit 113) may be implemented by one or more processing units. Each of the above units is implemented, for example, by one or a plurality of processors. For example, each of the above units may be implemented by causing a processor such as a CPU and a GPU to execute a program, that is, by software. Each of the above units may be implemented by a processor such as a dedicated IC, that is, hardware. Each of the above units may be implemented by using software and hardware in combination. When a plurality of processors are used, each processor may implement one of the units or may implement two or more of the units.

Next, the model construction process by the information processing device 100 according to the first embodiment is described. FIG. 2 is a flowchart illustrating an example of the model construction process according to the first embodiment.

The acquisition unit 102 acquires, for example, a category variable designated by the user (Step S101). The data number calculation unit 103 calculates the number of pieces of data of each category represented by the acquired category variable (Step S102). The weight calculation unit 104 calculates the weight of the regularization term using the calculated number of pieces of data (Step S103). The regularization term configuration unit 111 configures a regularization term including the calculated weight (Step S104). The construction unit 112 constructs the regression model MA by optimizing the loss function including the regularization term (Step S105) and ends the model construction process.

Next, details of processing by each unit of the information processing device 100 are further described.

Hereinafter, it is assumed that the total number of pieces of data (input data, process data) acquired by the acquisition unit 102 is n (n is an integer of 2 or more), and each piece of data includes numerical values representing h (h is an integer of 1 or more) explanatory variables and one objective variable. That is, data is represented by (xᵢ, yᵢ), xᵢ∈R^{h}, yᵢ∈R, i=1, . . . , and n. xᵢ is an explanatory variable of the h-dimensional vertical vector. yᵢ is a scalar objective variable.

For example, in the case of a linear regression model, the construction unit 112 solves an optimization problem for minimizing a loss function represented by the following Formula (7) using the acquired data thereby estimating the parameters of the regression model MA, that is, the regression coefficient for each explanatory variable.

$$\hat{β} = arg {min}_{{β}_{0} , β} {\sum }_{i} {( {y}_{i} - {β}_{0} - {β}^{T} {x}_{i} )}^{2} + λ {\sum }_{j , k ∈ G , j \neq k} {w}_{jk} \vert {β}_{j} - {β}_{k} \vert \qquad ( 7 )$$

G represents a set of indexes of dummy variables representing categories. wⱼₖ represents a weight for the combination of the category j and the category k. The weight wⱼₖ takes a larger value when the difference between the numbers of pieces of data of the two categories is large. β represents a regression coefficient. λ represents a hyperparameter that adjusts the balance between the sum of squares error and the regularization term.

The conversion of the category variable into the dummy variable may be performed by the acquisition unit 102 when the input data is acquired or may be performed by another configuration unit (the regularization term configuration unit 111, the construction unit 112, and the like).

The number of category variables converted into the dummy variables may be one or two or more. The category variable to be converted into the dummy variable may be designated in advance by a user or the like or may be selected from the plurality of explanatory variables using characteristics of data or the like. For example, an explanatory variable that is not a continuous value but a discrete value may be selected as the category variable.

A set of indexes that are information for identifying the dummy variable converted from the category variable is a set G. Hereinafter, a case where there is one category variable to be converted into a dummy variable is mainly described.

The first term on the right side of Formula (7) includes a sum of squares error. For example, the sum of squares error is smaller when the regression coefficient of the category corresponding to the derivative product is integrated into the regression coefficient of the category corresponding to the parent product having characteristics similar to the derivative product than when the regression coefficient of the category corresponding to the derivative product is integrated into the regression coefficient of another category having different characteristics.

The second term on the right side of Formula (7) includes a regularization term configured by the regularization term configuration unit 111. The regularization term of Formula (7) is a regularization term in which a weight based on the number of pieces of data between two categories is added to the L1 norm between the regression coefficients for each category. For example, when the difference between the numbers of pieces of data of two categories (category j, category k) is large, a larger penalty is given. As a result, the regression coefficients of these two categories are actively integrated.

Due to the above two effects according to the first and second terms, an estimation result is obtained in which the regression coefficient of the derivative product having a small number of pieces of data is integrated into the regression coefficient of the parent product having a large number of pieces of data.

In Formula (7), the L1 norm is used, but instead of the L1 norm, for example, a norm of another form designated by the user may be used. That is, the norm may be an L^{p} norm (p is a real number of 0 or more).

When there are a plurality of category variables to be converted into dummy variables, the second term of Formula (7) may be converted into the following Formula (8) below.

$$λ {\sum }_{i ∈ T} {α}_{i} {\sum }_{j , k ∈ G , j \neq k} {w}_{k} \vert {β}_{i} - {β}_{k} \vert \qquad ( 8 )$$

T represents a set of category variables considered in the regularization term. i represents identification information (index) for identifying a category variable included in the set T. αᵢ represents a parameter for adjusting the degree of influence of each category variable. G represents a set of indexes of dummy variables obtained by converting the category variable for each of the plurality of category variables.

The regularization term configuration unit 111 may constitute a regularization term as in the following Formula (9). The weight of Formula (9) corresponds to a weight calculated by the τ-th power of a value sⱼₖ, which is a statistic reflecting the influence of the number of pieces of data. For example, the weight calculation unit 104 calculates such a weight as a weight based on the number of pieces of data between two categories. SE(⋅) represents a standard error.

$$λ {\sum }_{j , k ∈ G , j \neq k} {( {s}_{j k}^{- 1} )}^{τ} \vert {β}_{j} - {β}_{k} \vert = λ {\sum }_{j , k ∈ G , j \neq k} {\{ \frac{SE ( {\tilde{β}}_{j} - {\tilde{β}}_{k} )}{\vert {\tilde{β}}_{j} - {\tilde{β}}_{k} \vert} \}}^{τ} \vert {β}_{j} - {β}_{k} \vert \qquad ( 9 )$$

The value Six may be calculated using, for example, a variance, a standard deviation, an expected value, a median value, a test amount, a p value of the test amount, a probability density for the test amount, and the like with respect to data or an initial estimation amount. For example, the value sⱼₖ of Formula (9) corresponds to a value calculated from the T test amount with respect to the difference of the initial estimation amount of the regression coefficient.

The loss function may include a penalty (regularization term) for each β, such as Ridge, least absolute shrinkage and selection operator (Lasso), smoothly clipped absolute derivation (SCAD), minimax concave penalty (MCP), a Lq norm (0≤q<1), and Elastic Net, in addition to the above regularization terms.

In Formula (7), a loss function using a square error (sum of squares error) is used, but the loss function is not limited thereto. For example, an absolute value loss, a quantile loss, a Huber loss, a cross entropy loss, an epsilon sensitivity loss, a logistic loss, a 0-1 loss, an exponent loss, a hinge loss, a smoothing hinge loss, and the like may be used as the loss function. In addition, a loss function for which the first term is weighted according to the reliability of each data and the date and time may be used.

In addition, the model to which the present embodiment can be applied is not limited to the linear regression model and may be any model as long as it is a model expressed using parameters. For example, a logistic regression model, a Poisson regression model, a generalized linear model, a generalized additive model, a decision tree, a neural network, or the like may be used.

Next, an example of calculation of the weight wⱼₖ by the weight calculation unit 104 is described. For each of a plurality of combinations including two categories, the weight calculation unit 104 obtains a value representing a difference in the number of pieces of data, for example, as in the following Formula (10).

$${w}_{j k} = \frac{\vert {N}_{A} - {N}_{B} \vert}{max ( {N}_{A} , {N}_{B} )} \qquad ( 10 )$$

Nⱼ and Nₖ are the numbers of pieces of data included in the category j and the category k. For example, when N_{A}>N_{B}, the above formula becomes 1−N_{B}/N_{A} and is equivalent to a result obtained by scaling the ratio between the small production category and the mass production category to a value of 0 or more and 1 or less.

The weight calculation unit 104 may calculate a value that does not use max(N_{A}, N_{B}) in the denominator of Formula (10), that is, a value without scaling, as the weight wⱼₖ. In the denominator, min (N_{A}, N_{B}) may be used instead of max (N_{A}, N_{B}). In the numerator, any other norm for the difference may be used instead of the absolute value of the difference of the number of pieces of data.

As described above, the weight calculation unit 104 may calculate the weight wⱼₖ that is a value representing a ratio such as max(N_{A}, N_{B})/min(N_{A}, N_{B}).

The weight calculation unit 104 may calculate a value obtained by setting the weight wⱼₖ calculated by any of the above methods to the power of τ as the final weight wⱼₖ, for example, using the value τ set by the user. τ may be a real number.

Next, an example of output by the output control unit 113 is described. After the regression model MA is constructed by the construction unit 112, the output control unit 113 outputs the regression coefficient for each explanatory variable.

The output control unit 113 may output a regression coefficient corresponding to λ with the minimum error. For example, the construction unit 112 estimates a regression coefficient for a plurality of λ by cross validation or generalized cross validation. The output control unit 113 outputs a regression coefficient corresponding to λ with the minimum error among the plurality of λ's. The output control unit 113 may output a regression coefficient corresponding to λ selected according to a predetermined rule (one standard error rule and the like) among the plurality of λ's. The output control unit 113 may output a regression coefficient corresponding to the designated λ among the plurality of λ's.

The output control unit 113 may output the regression coefficient for the category variable separately from the regression coefficient of the explanatory variable other than the category variable.

The output control unit 113 may output the regression coefficient (regression model) estimated using the loss function including the regularization term and the regression coefficient estimated using the loss function not including the regularization term in a combined manner. For example, in addition to the construction of the regression model MA using the loss function including the regularization term as described above, the construction unit 112 performs the construction of a regression model MB (second regression model) using the loss function not including the regularization term configured by the regularization term configuration unit 111. The loss function not including the regularization term configured by the regularization term configuration unit 111 is, for example, a loss function not including the second term on the right side of Formula (7). For example, the output control unit 113 outputs the two regression models MA and MB estimated by the two estimation methods in a comparable manner.

As described above, in the present embodiment, for example, in the data analysis in mass production of multi-category products, the regression coefficient can be estimated while the regression coefficients are integrated between the categories in consideration of the number of pieces of data of each category. According to the present embodiment, since the regression coefficient of the small production derivative product is integrated into the regression coefficient of the mass production parent product, the estimation of the regression coefficient of the derivative product is stabilized. That is, a more appropriate model can be constructed as a model for performing analysis regarding the production system and the like. In addition, the integrated regression coefficient can be presented, for example, to an expert. Therefore, it is possible to improve the reliability of the expert with respect to the estimation result.

### Second Embodiment

In the first embodiment, by providing a regularization term that integrates regression coefficients between categories while the number of pieces of data of each category is considered, the regression coefficients are integrated between the derivative product and the parent product. In a second embodiment, a limit is given to the number of pieces of data in the calculation of the weight w added to the regularization term. As a result, it is possible to obtain a weight more suitable for reality.

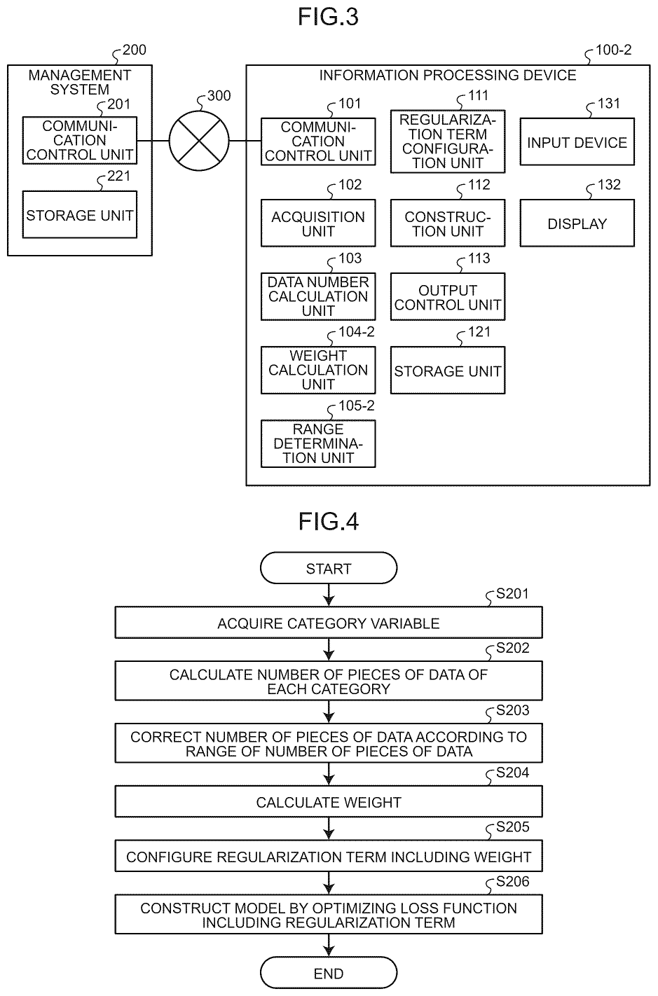

FIG. 3 is a block diagram illustrating an example of a configuration of an information processing device 100-2 according to the second embodiment. As illustrated in FIG. 3, the information processing device 100-2 includes the storage unit 121, the input device 131, the display 132, the communication control unit 101, the acquisition unit 102, the data number calculation unit 103, a weight calculation unit 104-2, a range determination unit 105-2, the regularization term configuration unit 111, the construction unit 112, and the output control unit 113.

The second embodiment is different from the first embodiment in a function of the weight calculation unit 104-2 and the addition of the range determination unit 105-2. Other configurations and functions are similar to those in FIG. 1 which is the block diagram of the information processing device 100 according to the first embodiment and thus are denoted by the same reference numerals, and description thereof here is omitted.

The range determination unit 105-2 determines a range to limit the number of pieces of data. For example, the range determination unit 105-2 determines the lower limit value and the upper limit value of the range of the number of pieces of data. Details of the range determination method are described below.

In addition, the range determination unit 105-2 performs a correction process of correcting the number of pieces of data according to the determined range. For example, for each of the plurality of categories, the range determination unit 105-2 performs the correction process of correcting the number of pieces of data to the upper limit value when the number of pieces of data is equal to or larger than the upper limit value and correcting the number of pieces of data to the lower limit value when the number of pieces of data is equal to or smaller than the lower limit value.

The weight calculation unit 104-2 calculates a weight based on the number of pieces of data using the corrected number of pieces of data.

Next, the model construction process by the information processing device 100-2 according to the second embodiment is described with reference to FIG. 4. FIG. 4 is a flowchart illustrating an example of the model construction process according to the second embodiment.

Since Steps S201 to S202 are similar to Steps S101 to S102 of the information processing device 100 of the first embodiment, the description thereof is omitted.

The range determination unit 105-2 corrects the number of pieces of data calculated in Step S202 according to the range of the number of pieces of data (Step S203). Note that the range of the number of pieces of data may be determined before the model construction process or may be determined in the model construction process.

The weight calculation unit 104-2 calculates the weight of the regularization term using the corrected number of pieces of data (Step S204).

Since Steps S205 to S206 are similar to Steps S104 to S105 in the information processing device 100 of the first embodiment, the description thereof is omitted.

Next, the limitation (correction) of the number of pieces of data is further described.

The accuracy of the estimation of the regression coefficient in each category is improved as the data of the corresponding category is larger. Therefore, also for the parent product, the larger the number of pieces of data, the greater the advantage of integrating the regression coefficient of the small production derivative product with the regression coefficient of the parent product.

An example of integration of regression coefficients between categories in data of three categories of {A, B, C} is considered. The numbers of pieces of data N_{A}, N_{B}, and N_{C} of the categories A, B, and C are assumed to be N_{A}=500, N_{B}=100, and N_{C}=1000, respectively. In this example, the numbers of pieces of data of the category A and the category C are sufficiently large, and the number of pieces of data of the category B is small. In this example, the numbers of data of the category A and the category C are sufficiently large, and the number of pieces of data of the category B is small. As a relationship between the plurality of categories, it is assumed that the category B is a derivative product of the category A. Under this assumption, the regression coefficient of the category B is desirably integrated into the regression coefficient of the category A.

In the above example, when the weight is calculated by the representative calculation formula provided in the first embodiment, for example, w_{AB}=0.8 and w_{BC}=0.9. Since the weight w_{BC} for the combination of the category B and the category C is larger, a regularization term that more actively integrates the regression coefficients of the category B and the category C is configured. As described above, even though sufficient data is obtained in the category A, since the number of pieces of data of the category C is larger, the weight unsuitable for reality, such as bringing the category B closer to the category C, is calculated.

Therefore, in the present embodiment, the range determination unit 105-2 corrects the number of pieces of data using a cut-off function as in the following Formula (11). Formula (11) corresponds to a formula representing correction using the upper limit value of the number of pieces of data.

$${f}_{cut} ( N ) = min ( N , {C}_{max} ) \qquad ( 11 )$$

According to Formula (11), when the number of pieces of data N is larger than the upper limit value Cₘₐₓ (for example, 500), the number of pieces of data N is corrected to Cₘₐₓ. In the above example, when the cut-off function is used, the number of pieces of data N_{C} (=1000) is corrected to 500. As a result, the weight calculation unit 104-2 calculates w_{AB}=w_{BC}=0.8 as the weights of category B and category C. As a result, the regression coefficient of the derivative product (the category B) is more actively integrated with the regression coefficient of the product (the category A) in which the term of the sum of squares error is smaller.

In addition, w_{AC}=0 is calculated as the weights of the category A and the category C in association with the correction of the number of pieces of data as described above. As a result, unnecessary integration between the category A and the category C having a sufficiently large number of pieces of data can be suppressed.

The range determination unit 105-2 may perform correction using the lower limit value of the number of pieces of data. For example, the range determination unit 105-2 may correct the number of pieces of data using a cut-off function as in the following Formula (12). Formula (12) corresponds to a formula representing correction using the lower limit value of the number of pieces of data. According to Formula (12), when the number of pieces of data N is smaller than the lower limit value Cₘᵢₙ, the number of pieces of data N is corrected to Cₘᵢₙ.

$${f}_{cut} ( N ) = max ( N , {C}_{min} ) \qquad ( 12 )$$

The range determination unit 105-2 may perform correction using both the upper limit value and the lower limit value of the number of pieces of data. For example, the range determination unit 105-2 may correct the number of pieces of data using a cut-off function as in the following Formula (13). According to Formula (13), the number of pieces of data N is corrected to be included within the range of [Cₘᵢₙ, Cₘₐₓ].

$${f}_{cut} ( N ) = max ( min ( N , {C}_{max} ) , {C}_{min} ) \qquad ( 13 )$$

Next, details of a method of determining the range of the number of pieces of data [Cₘᵢₙ, Cₘₐₓ] are described. For example, Cₘᵢₙ and Cₘₐₓ may be designated by the user. That is, the range determination unit 105-2 determines the range [Cₘᵢₙ, Cₘₐₓ] according to Cₘᵢₙ and Cₘₐₓ designated by the user.

Cₘᵢₙ and Cₘₐₓ may be determined according to values stored in the storage unit 121 or the like. For example, the acquisition unit 102 reads the values of Cₘᵢₙ and Cₘₐₓ from the storage unit 121. The range determination unit 105-2 determines a range [Cₘᵢₙ, Cₘₐₓ] according to the read Cₘᵢₙ and Cₘₐₓ.

The range determination unit 105-2 may use Formula (13) as a cut-off function for which only one of the upper limit value and the lower limit value is limited by setting Cₘᵢₙ to ∞ or setting Cₘₐₓ to −∞.

Furthermore, the range determination unit 105-2 may determine Cₘᵢₙ and Cₘₐₓ from the input data by the following procedure.
1. For each of the plurality of categories, a plurality of subsets each including the same number (number of pieces of data) of input data as a portion of a plurality of input data including a category variable are generated.
2. The statistical value of the objective variable included in the plurality of generated subsets is calculated.
3. The minimum value of the number of pieces of data of the category for which the variation in the plurality of statistical values is smaller than a threshold THA (first threshold) is calculated as the upper limit value.
4. The maximum value of the number of pieces of data of the category for which the variation in the plurality of statistical values is smaller than a threshold THB (second threshold) is calculated as the lower limit value.

More specifically, the range determination unit 105-2 determines Cₘᵢₙ and Cₘₐₓ, for example, by the following procedure.
(S1) Using bootstrap sampling, a plurality of subsets of the same number of pieces of data are sampled for each category.
(S2) An average value of objective variables of data included in each subset for each category is calculated.
(S3) When the standard deviation of the average value of the objective variable in each subset is smaller than the threshold THA, and the number of pieces of data of the category is smaller than the current Cₘₐₓ, the number of pieces of data of the category is updated to Cₘₐₓ.
(S4) When the standard deviation of the average value of the objective variable in each subset is larger than the threshold THB, and the number of pieces of data of the category is larger than the current Cₘᵢₙ, the number of pieces of data of the category is updated to Cₘᵢₙ.
(S5) S3 and S4 are repeatedly performed for all categories.

In the above example, the average value is used as the statistical value, but the statistical value is not limited thereto, and for example, another index such as a median value may be used. In addition, the index indicating the variation is not limited to the standard deviation, and another index such as dispersion may be used.

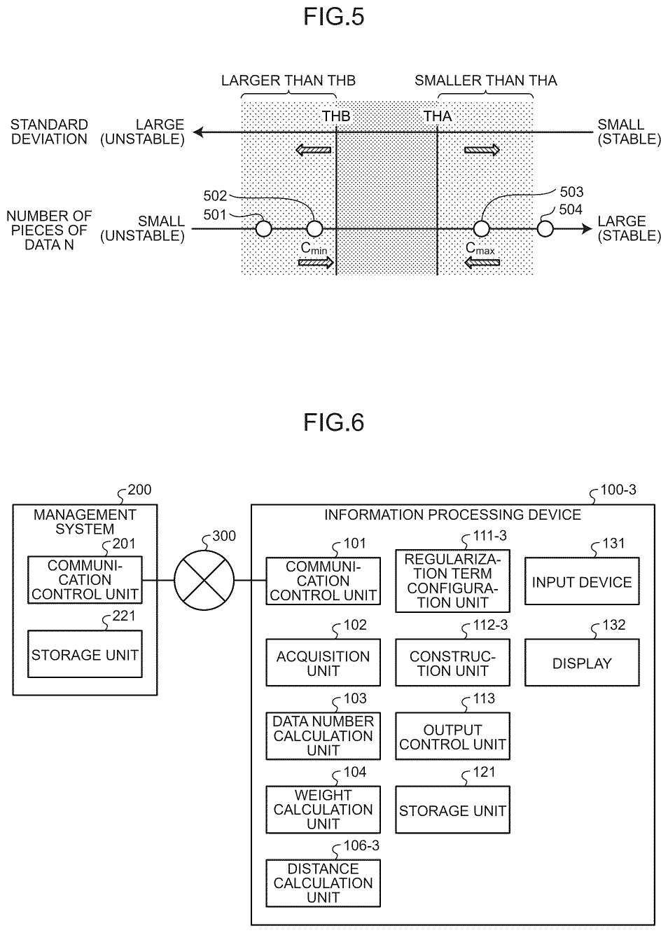

FIG. 5 is a diagram illustrating an outline of a procedure for determining Cₘᵢₙ and Cₘₐₓ as described above. It can be interpreted that the above procedure is intended to determine Cₘᵢₙ and Cₘₐₓ so that the following conditions are satisfied in all categories.
Condition: When the number of pieces of data is equal to or greater than Cₘₐₓ, the estimation is stable, and thus the magnitude of the number of pieces of data is not distinguished when the number of pieces of data is equal to or greater than Cₘₐₓ.
Condition: When the number of pieces of data is equal to or less than Cₘᵢₙ, the estimation is unstable, and thus the magnitude of the number of pieces of data is not distinguished when the number of pieces of data is equal to or less than Cₘᵢₙ.

As illustrated in FIG. 5, the larger the value of the standard deviation is, the more unstable the estimation is. However, the smaller the value of the number of pieces of data is, the more unstable the estimation is.

The above-described S3 satisfies the criterion that the standard deviation is smaller than the threshold THA and corresponds to a search using the minimum number of pieces of data as the upper limit value Cₘₐₓ. In this manner, it is assumed that Cₘₐₓ is not obtained, and for example, the value of the number of pieces of data 504 of category 4 is determined as Cₘₐₓ. In this case, there may be a situation in which the number of pieces of data 503 of category 3 is not cut off, even though the estimation is stable.

The above-described S4 satisfies the criterion that the standard deviation is larger than the threshold THB and corresponds to a search using the largest number of pieces of data as the lower limit value Cₘᵢₙ. In this manner, it is assumed that Cₘᵢₙ is not obtained, and for example, the value of the number of pieces of data 501 of category 1 is determined as Cₘᵢₙ. In this case, there may be a situation in which the number of pieces of data 502 of category 2 is not cut off, even though the estimation is unstable.

As described above, in the second embodiment, by using the cut-off function with respect to the number of pieces of data, it is possible to avoid the influence of the category having the very large number of pieces of data or the category having the very small number of pieces of data which is not suitable for the estimation of the regression coefficient in reality.

### Third Embodiment

The information processing device according to a third embodiment uses not only regularization term including a weight based on the number of pieces of data but also a regularization term including a weight based on a distance between categories other than the number of pieces of data.

FIG. 6 is a block diagram illustrating an example of a configuration of an information processing device 100-3 according to the third embodiment. As illustrated in FIG. 6, the information processing device 100-3 includes the storage unit 121, the input device 131, the display 132, the communication control unit 101, the acquisition unit 102, the data number calculation unit 103, the weight calculation unit 104, a distance calculation unit 106-3, a regularization term configuration unit 111-3, a construction unit 112-3, and the output control unit 113.

The third embodiment is different from the first embodiment in the addition of the distance calculation unit 106-3 and the functions of the regularization term configuration unit 111-3 and the construction unit 112-3. Other configurations and functions are similar to those in FIG. 1 which is the block diagram of the information processing device 100 according to the first embodiment and thus are denoted by the same reference numerals, and description thereof here is omitted.

For a plurality of combinations each including two categories included in a plurality of categories, the distance calculation unit 106-3 calculates a distance between the two categories included in the combination.

The regularization term configuration unit 111-3 further configures a regularization term in which the strength of regularization changes according to the distance.

The construction unit 112-3 learns the regression model MA using a loss function further including a regularization term in which the strength of regularization changes according to the distance.

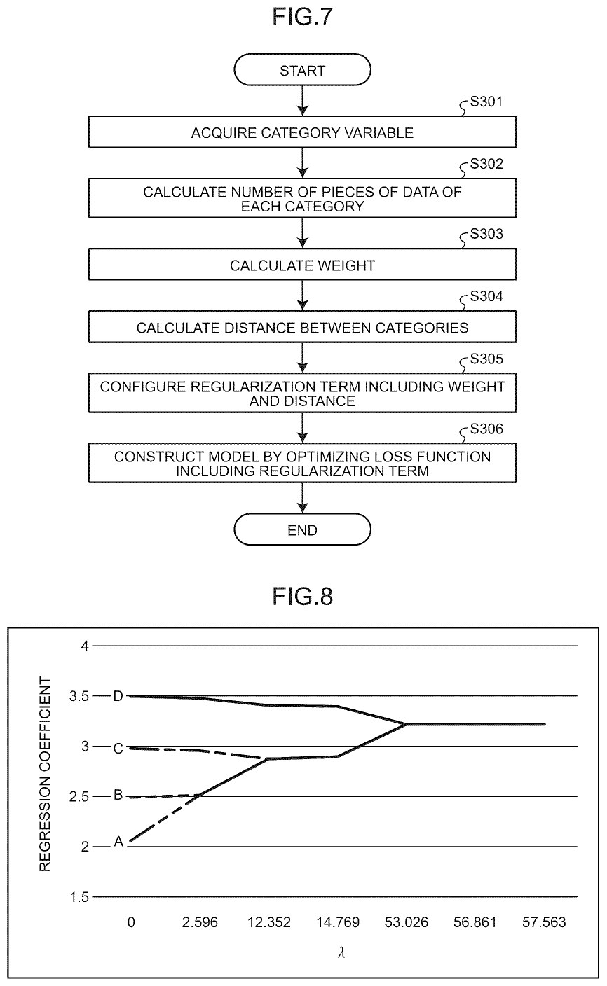

Next, the model construction process by the information processing device 100-3 according to the third embodiment is described with reference to FIG. 7. FIG. 7 is a flowchart illustrating an example of the model construction process according to the third embodiment.

Since Steps S301 to S303 are similar to Steps S101 to S103 in the information processing device 100 of the first embodiment, the description thereof is omitted.

The distance calculation unit 106-3 calculates a distance between two categories included in each of the plurality of combinations (Step S304). The regularization term configuration unit 111-3 configures a regularization term including the weight calculated by the weight calculation unit 104 and also configures a regularization term including the distance calculated by the distance calculation unit 106-3 (Step S305). The construction unit 112-3 constructs the regression model MA by optimizing the loss function including the regularization term (Step S306) and ends the model construction process.

Next, a distance between categories and a regularization term in which the strength of regularization changes according to the distance is further described.

In the present embodiment, a loss function represented by the following Formula (14) is used. In the loss function of Formula (14), the third term on the right side is newly added.

$$\hat{β} = arg {min}_{{β}_{0} β} {\sum }_{i} {( {y}_{i} - {β}_{0} - {β}^{T} {x}_{i} )}^{2} + {λ}_{1} {\sum }_{j , k ∈ G , j \neq k} {w}_{j i} \vert {β}_{j} - {β}_{k} \vert + {λ}_{2} {\sum }_{j , k ∈ G , j \neq k} {d}_{j k}^{- 1} \vert {β}_{j} - {β}_{k} \vert \qquad ( 14 )$$

The weight wⱼₖ represents a weight calculated based on the number of pieces of data. d⁻¹ⱼₖ represents the reciprocal of a distance dⱼₖ between the category j and the category k calculated from information other than the number of pieces of data.

The distance calculation unit 106-3 may calculate the reciprocal d⁻¹ⱼₖ of the distance as in the following Formula (15). βⱼ˜ and βₖ˜ are regression coefficients of the category j and the category k as initial estimation amounts obtained from a result of normal linear regression.

$${d}_{jk}^{- 1} = \frac{1}{{d}_{jk}} = \frac{1}{\vert {\tilde{β}}_{i} - {\tilde{β}}_{k} \vert} \qquad ( 15 )$$

the category k are close to each other in terms other than the number of pieces of data, it is possible to further obtain an effect that the category j and the category k are easily integrated. The integration effect by the number of pieces of data and the integration effect by the distance can be adjusted using the hyperparameter λ(λ₁, λ₂).

The method of calculating the distance dⱼₖ is not limited to the above, and any other method may be used. Hereinafter, an example of another calculation method is described.
The distance dⱼₖ is calculated from the estimation result of the model constructed at the past time point.
A value obtained by quantifying the difference between the category names is calculated as the distance dⱼₖ.
A value obtained by quantifying the relationship between the categories based on the domain knowledge is calculated as the distance dⱼₖ.

The distance calculation unit 106-3 may calculate a value obtained by setting the distance dⱼₖ calculated by any of the above methods to the power of τ as the final distance dⱼₖ.

The regularization term configuration unit 111-3 may configure one regularization term obtained by integrating the second term and the third term on the right side of Formula (15). For example, the second term and the third term on the right side of Formula (15) can be configured as one regularization term having λ₁wⱼₖ+λ₂d⁻¹ⱼₖ as a weight. λ₁wⱼₖ+λ₂d⁻¹ⱼₖ can be interpreted as a weight for one regularization term.

The weights of the regularization terms to be integrated may be calculated as the output of the function f(wⱼₖ, d⁻¹ⱼₖ). The function f may be any function that inputs wⱼₖ and d⁻¹ⱼₖ (or dⱼₖ) and outputs a value corresponding to a weight.

In this manner, in the third embodiment, it is possible to integrate the regression coefficients in consideration of not only the number of pieces of data but also the relationship between the available categories.

### (Exemplary Output)

Another example of the method of outputting the estimation result (regression coefficient) or the like is described. Hereinafter, an example of outputting the estimation result so that a process of integrating the regression coefficients can be more clearly understood is described. Note that a case where the present disclosure is applied to the first embodiment is described as an example, but the same procedure can be applied to the second and third embodiments.

For example, the construction unit 112 changes the hyperparameter λ of Formula (7) to a plurality of values and obtains the regression coefficient of the regression model MA for each of the plurality of λ. That is, the construction unit 112 constructs a plurality of regression models MA (regression coefficients) by learning for which the hyperparameter λ for controlling the strength of the regularization term is changed to a plurality of values.

The output control unit 113 outputs information indicating changes of the plurality of regression models MA with respect to the plurality of λ values. For example, the output control unit 113 outputs the value of the regression coefficient with respect to λ on coordinates with λ as the horizontal axis and the regression coefficient as the vertical axis. The change of the regression coefficient with respect to λ can be interpreted as corresponding to the path of the solution.

FIG. 8 is a diagram illustrating an output example of the estimation result of the regression coefficient using the input data including the products of the four categories A, B, C, and D. FIG. 8 illustrates an example in a case where the numbers of pieces of data N_{A}, N_{B}, N_{C}, and N_{D} of the categories A, B, C, and D are N_{A}=19, N_{B}=77, N_{C}=198, and N_{D}=906.

As illustrated in FIG. 8, with an increase in A, it is possible to confirm a series of flows in which the regression coefficients are integrated into a category being close to the category and having a large number of pieces of data in ascending order from the category having a small number of pieces of data and finally integrated into one regression coefficient.

The relationship between categories in actual mass production may be more complex. The expert can grasp the relationship between the categories from the data by checking the path of the solution as illustrated in FIG. 8.

As described above, according to the first to third embodiments, a more appropriate model can be constructed as a model for performing analysis regarding a production system or the like.

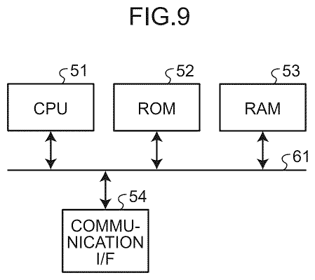

Next, a hardware configuration of the information processing device according to the first to third embodiments is described with reference to FIG. 9. FIG. 9 is an explanatory diagram illustrating a hardware configuration example of the information processing device according to the first to third embodiments.

The information processing device according to the first to third embodiments includes a control device such as a central processing unit (CPU) 51, a storage device such as a read only memory (ROM) 52 and a random access memory (RAM) 53, a communication I/F 54 that is connected to a network and performs communication, and a bus 61 that connects the respective units.

The program executed by the information processing device according to the first to third embodiments is provided by being incorporated in the ROM 52 or the like in advance.

The program executed by the information processing device according to the first to third embodiments may be configured to be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Furthermore, the program executed by the information processing device according to the first to third embodiments may be configured to be stored on a computer connected to a network such as the Internet and provided by being downloaded via the network. In addition, the program executed by the information processing device according to the first to third embodiments may be configured to be provided or distributed via a network such as the Internet.

The program executed by the information processing device according to the first to third embodiments can cause the computer to function as each unit of the information processing device described above. In this computer, the CPU 51 can read the program from a computer-readable storage medium onto a main storage device and execute the program.

Configuration examples of the embodiment are described below.

Configuration Example 1. According to an embodiment, an information processing device includes one or more hardware processors configured to calculate a number of pieces of data that is a number of pieces of input data for each of a plurality of categories, by using n pieces of input data each including a plurality of explanatory variables including a category variable representing any of the plurality of categories, where n is an integer of 2 or more. The hardware processors are configured to calculate, for a plurality of combinations each including two of the categories included in the plurality of categories, a weight based on a number of pieces of data between two of the categories included in a combination. The hardware processors are configured to learn a first regression model that estimates an objective variable from the plurality of explanatory variables by using a loss function including a regularization term in which a strength of regularization changes according to the weight.

Configuration Example 2. In the information processing device according to configuration example 1, the regularization term includes multiplication of the weight and an Le norm of a difference between regression coefficients of first regression models of the two categories included in the combination, where p is a real number of 0 or more.

Configuration Example 3. In the information processing device according to configuration example 1 or 2, the one or more hardware processors are configured to calculate the weight that is a difference between numbers of pieces of data of the two categories included in the combination.

Configuration Example 4. In the information processing device according to any one of configuration examples 1 to 3, the one or more hardware processors are configured to calculate the weight that is a ratio between numbers of pieces of data of the two categories included in the combination.

Configuration Example 5. In the information processing device according to any one of configuration examples 1 to 4, the one or more hardware processors are configured to calculate the weight that has a value of 0 or more and 1 or less or the weight that has a value causing a sum of weights for the plurality of combinations to be 1.

Configuration Example 6. In the information processing device according to any one of configuration examples 1 to 5, the one or more hardware processors are configured to calculate the weight that is a t-th power of a value based on the number of pieces of data between the two categories included in the combination.

Configuration Example 7. In the information processing device according to any one of configuration examples 1 to 6, the one or more hardware processors are configured to perform, for each of the plurality of categories, a correction process of correcting the number of pieces of data to an upper limit value when the number of pieces of data is equal to or larger than the upper limit value and correcting the number of pieces of data to a lower limit value when the number of pieces of data is equal to or smaller than the lower limit value.

Configuration Example 8. In the information processing device according to configuration example 7, the one or more hardware processors are configured to perform the correction process using a designated upper limit value and a designated lower limit value.

Configuration Example 9. In the information processing device according to configuration example 7, each of a plurality of pieces of input data includes an objective variable corresponding to each of the plurality of explanatory variables. The hardware processors are configured to generate, for each of the plurality of categories, a plurality of subsets each including a same number of pieces of input data as a portion of the plurality of pieces of input data including the category variable representing the category and calculate a statistical value of the objective variable included in the plurality of generated subsets. The hardware processors are configured to calculate, as the upper limit value, a minimum value of the number of pieces of data of the category for which a variation in a plurality of statistical values is smaller than a first threshold. The hardware processors are configured to calculate, as the lower limit value, a maximum value of the number of pieces of data of the category for which a variation in the plurality of statistical values is larger than a second threshold.

Configuration Example 10. In the information processing device according to any one of configuration examples 1 to 9, the one or more hardware processors are configured to calculate a distance between two of the categories included in the combination; and learn the first regression model by using the loss function further including a regularization term in which the strength of the regularization changes according to the distance.

Configuration Example 11. In the information processing device according to any one of configuration examples 1 to 10, the one or more hardware processors are configured to calculate the weight for the plurality of combinations each including two of the categories designated from the plurality of categories.

Configuration Example 12. In the information processing device according to any one of configuration examples 1 to 11, the one or more hardware processors are configured to output names of the plurality of categories and calculate the weight for the plurality of combinations each including two of the categories corresponding to names designated from output names.

Configuration Example 13. In the information processing device according to any one of configuration examples 1 to 12, the one or more hardware processors are configured to learn a second regression model that estimates an objective variable from the plurality of explanatory variables using a loss function that does not include the regularization term; and output the first regression model and the second regression model.

Configuration Example 14. In the information processing device according to any one of configuration examples 1 to 13, the one or more hardware processors are configured to construct a plurality of first regression models by learning for which a parameter of controlling the strength of the regularization term is changed to a plurality of values; and output information indicating changes of the plurality of first regression models with respect to the plurality of values.

Configuration Example 15. According to an embodiment, an information processing method is implemented by a computer of an information processing device. The method includes calculating a number of pieces of data that is a number of pieces of input data for each of a plurality of categories, by using n pieces of input data each including a plurality of explanatory variables including a category variable representing any of the plurality of categories, where n is an integer of 2 or more. The method includes calculating, for a plurality of combinations each including two of the categories included in the plurality of categories, a weight based on a number of pieces of data between two of the categories included in a combination. The method includes learning a first regression model that estimates an objective variable from the plurality of explanatory variables by using a loss function including a regularization term in which a strength of regularization changes according to the weight.

Configuration Example 16. According to an embodiment, a computer program product has a non-transitory computer readable medium including instructions stored thereon. When executed by a computer, the instructions cause the computer to execute calculating a number of pieces of data that is a number of pieces of input data for each of a plurality of categories, by using n pieces of input data each including a plurality of explanatory variables including a category variable representing any of the plurality of categories, where n is an integer of 2 or more. The instructions cause the computer to execute calculating, for a plurality of combinations each including two of the categories included in the plurality of categories, a weight based on a number of pieces of data between two of the categories included in a combination. The instructions cause the computer to execute learning a first regression model that estimates an objective variable from the plurality of explanatory variables by using a loss function including a regularization term in which a strength of regularization changes according to the weight.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to:
calculate a number of pieces of data that is a number of pieces of input data for each of a plurality of categories, by using n pieces of input data each including a plurality of explanatory variables including a category variable representing any of the plurality of categories, n being an integer of 2 or more;
calculate, for a plurality of combinations each including two of the categories included in the plurality of categories, a weight based on the number of pieces of data between two of the categories included in a combination; and
learn a first regression model that estimates an objective variable from the plurality of explanatory variables by using a loss function including a regularization term in which a strength of regularization changes according to the weight.

2. The information processing device according to claim 1, wherein
the regularization term includes multiplication of the weight and an LA norm of a difference between regression coefficients of first regression models of the two categories included in the combination, p being a real number of 0 or more.

3. The information processing device according to claim 1, wherein
the one or more hardware processors are configured to calculate the weight that is a difference between numbers of pieces of data of the two categories included in the combination.

4. The information processing device according to claim 1, wherein
the one or more hardware processors are configured to calculate the weight that is a ratio between numbers of pieces of data of the two categories included in the combination.

5. The information processing device according to claim 1, wherein
the one or more hardware processors are configured to calculate the weight that has a value of 0 or more and 1 or less or the weight that has a value causing a sum of weights for the plurality of combinations to be 1.

6. The information processing device according to claim 1, wherein
the one or more hardware processors are configured to calculate the weight that is a t-th power of a value based on the number of pieces of data between the two categories included in the combination.

7. The information processing device according to claim 1, wherein
the one or more hardware processors are configured to perform, for each of the plurality of categories, a correction process of correcting the number of pieces of data to an upper limit value when the number of pieces of data is equal to or larger than the upper limit value and correcting the number of pieces of data to a lower limit value when the number of pieces of data is equal to or smaller than the lower limit value.

8. The information processing device according to claim 7, wherein
the one or more hardware processors are configured to perform the correction process using a designated upper limit value and a designated lower limit value.

9. The information processing device according to claim 7, wherein
each of a plurality of pieces of input data includes an objective variable corresponding to each of the plurality of explanatory variables, and
the one or more hardware processors are configured to:
generate, for each of the plurality of categories, a plurality of subsets each including a same number of pieces of input data as a portion of the plurality of pieces of input data including the category variable representing the category and calculate a statistical value of the objective variable included in the plurality of generated subsets;
calculate, as the upper limit value, a minimum value of the number of pieces of data of the category for which a variation in a plurality of statistical values is smaller than a first threshold; and
calculate, as the lower limit value, a maximum value of the number of pieces of data of the category for which a variation in the plurality of statistical values is larger than a second threshold.

10. The information processing device according to claim 1, wherein the one or more hardware processors are configured to:
calculate a distance between two of the categories included in the combination; and
learn the first regression model by using the loss function further including a regularization term in which the strength of the regularization changes according to the distance.

11. The information processing device according to claim 1, wherein
the one or more hardware processors are configured to calculate the weight for the plurality of combinations each including two of the categories designated from the plurality of categories.

12. The information processing device according to claim 1, wherein
the one or more hardware processors are configured to output names of the plurality of categories and calculate the weight for the plurality of combinations each including two of the categories corresponding to names designated from output names.

13. The information processing device according to claim 1, wherein
the one or more hardware processors are configured to:
learn a second regression model that estimates an objective variable from the plurality of explanatory variables using a loss function that does not include the regularization term; and
output the first regression model and the second regression model.

14. The information processing device according to claim 1, wherein
the one or more hardware processors are configured to:
construct a plurality of first regression models by learning for which a parameter of controlling the strength of the regularization term is changed to a plurality of values; and
output information indicating changes of the plurality of first regression models with respect to the plurality of values.

15. An information processing method implemented by a computer of an information processing device, the method comprising:
calculating a number of pieces of data that is a number of pieces of input data for each of a plurality of categories, by using n pieces of input data each including a plurality of explanatory variables including a category variable representing any of the plurality of categories, n being an integer of 2 or more;
calculating, for a plurality of combinations each including two of the categories included in the plurality of categories, a weight based on the number of pieces of data between two of the categories included in a combination; and
learning a first regression model that estimates an objective variable from the plurality of explanatory variables by using a loss function including a regularization term in which a strength of regularization changes according to the weight.

16. A computer program product having a non-transitory computer readable medium including instructions stored thereon, wherein the instructions, when executed by a computer, cause the computer to execute:
calculating a number of pieces of data that is a number of pieces of input data for each of a plurality of categories, by using n pieces of input data each including a plurality of explanatory variables including a category variable representing any of the plurality of categories, n being an integer of 2 or more;
calculating, for a plurality of combinations each including two of the categories included in the plurality of categories, a weight based on the number of pieces of data between two of the categories included in a combination; and
learning a first regression model that estimates an objective variable from the plurality of explanatory variables by using a loss function including a regularization term in which a strength of regularization changes according to the weight.
